(19) United States
(12) Patent Application Publication
(10) Pub. No.: US 2018/0164437 A1
(43) Pub. Date: Jun. 14, 2018

(54) LASER SAFETY SCREEN AND METHOD

(71) Applicants: Laser Technology, Inc., Centennial, CO (US); Kama-Tech (HK) Limited, Hong Kong (HK)

(72) Inventors: Jeremy G. Dunne, Parker, CO (US); Jiyoon Chung, Aurora, CO (US)

(73) Assignees: Laser Technology, Inc., Centennial, CO (US); Kama-Tech (HK) Limited, Hong Kong (HK)

(21) Appl. No.: 15/835,776

(22) Filed: Dec. 8, 2017

Related U.S. Application Data
(60) Provisional application No. 62/432,385, filed on Dec. 9, 2016.

(51) Int. Cl. G01S 17/02; G01S 17/93; G02B 26/12; G02B 5/09

(52) U.S. Cl. CPC G01S 17/026; G01S 17/93; G02B 26/0816; G02B 5/09; G02B 26/124; G02B 26/121

(57) ABSTRACT

An improved and simplified laser safety screen and method utilizing a novel rotating mirrored polygon hub having mirrored surfaces with at least one of the surfaces in an orientation (or angle θ) other than parallel to the axis of rotation of the hub. In other words, the angle θ for each side of the polygon may be made independent for each phase and, in certain instances, a given phase can also be zero

### BACKGROUND OF THE INVENTION

The present invention relates, in general, to the field of laser-based safety screens (or curtains) and methods. More particularly, the present invention relates to an improved and simplified laser safety screen and method utilizing a novel rotating mirrored hub.

### SUMMARY OF THE INVENTION

The laser safety screen of the present invention is of particularly utility in the field of vehicle collision avoidance including unmanned aerial vehicles (UAVs). The principles of the present invention may also be utilized in vehicle detection applications for roadway traffic management (including speed measurement) as well as for officer, roadway maintenance and emergency personal safety at a roadside.

A laser safety screen in accordance with the present invention incorporates a novel, rotating polygon hub having mirrored surfaces with at least one (or more) of the surfaces in an orientation (or angle θ) other than parallel to the axis of rotation of the hub. In other words, the angle θ for each side of the polygon may be made independent for each phase and, in certain instances, a given phase can also be zero.

In certain implementations of the present invention, the hub may conveniently comprise a cube having its four sides comprising mirrored surfaces at differing angles θ with respect to the hub's axis of rotation. A laser beam then aimed at the hub as it rotates produces a unique and useful detectable pattern as will be more fully described hereinafter.

It should be noted that a hub in accordance with the principles of the present invention may be in the form of a polygon of any shape presenting mirrored surfaces of differing angles θ other than cubic including triangular, pentagonal, hexagonal, etc. and the like.

While the principles of the present invention have been disclosed herein with respect to their implementation in a laser safety screen, the same are likewise applicable to hand held devices such as laser rangefinders and speed measurement devices.

### BRIEF DESCRIPTION OF THE DRAWINGS

The aforementioned and other features and objects of the present invention and the manner of attaining them will become more apparent and the invention itself will be best understood by reference to the following description of a preferred embodiment taken in conjunction with the accompanying drawings, wherein:

FIG. 1 is an isometric phantom view of a representative hub in accordance with the principles of the present invention in the form of a cube having four mirrored surfaces M1 through M4 presenting respective and differing angles θ1 through θ4 to an incident laser beam as indicated as the hub is rotated through an angle ϕ;

FIG. 2A is a cut-away, top plan view of a possible implementation of a portion of a laser safety screen in accordance with the principles of the present invention incorporating the rotating hub of the preceding figure wherein the angle of the incident laser beam to a point on a mirrored surface of the hub is 15°;

FIG. 2B is an additional cut-away, top plan view of the implementation of a portion of the laser safety screen of the preceding figure wherein the angle of the incident laser beam to a point on a mirrored surface on the hub is 60°;

FIGS. 3 and 4 illustrate the mathematical relationships between the short range and long range scan angles in the representative embodiment of FIGS. 2A and 2B;

FIG. 5 is an image of a prototype laser safety screen in accordance with the principles of the present invention illustrating a laser source, mirror and hub rotating at a representative speed of between 1800 to 3000 RPM;

FIG. 6 is an image of a laser pattern produced by the prototype laser safety screen of the preceding figure as may be detected as the hub is rotated;

FIG. 7A is a graphical illustration of a detection data sample of detected data by time;

FIG. 7B is a related graphical illustration to that shown in the preceding figure wherein the measurement error is 2.0 cm to 3.0 cm (the effective measurement interval);

FIG. 8A is an image of the prototype laser safety screen of FIGS. 5 and 6 wherein contamination has been introduced in the output laser pattern;

FIG. 8B is another view of the image of the preceding figure showing a setup for producing experimental results at 90°;

FIG. 9A illustrates the experimental results of the setup of FIG. 8B at 90°; and

FIG. 9B illustrates the experimental results of the setup of the prototype laser safety screen of the preceding figures at 106°, 65.5°to 12°.

### DESCRIPTION OF A REPRESENTATIVE EMBODIMENT

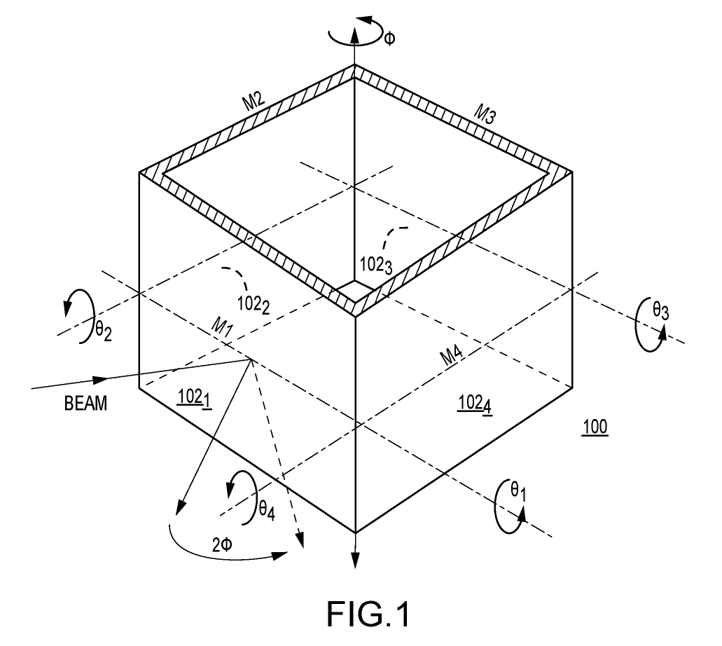

With reference now to FIG. 1, an isometric phantom view of a representative hub 100 in accordance with the principles of the present invention is shown in the form of a cube having four mirrored surfaces M1 through M4 presenting respective and differing angles θ1 through θ4 to an incident laser beam as indicated as the hub is rotated through an angle (θ). The mirrored surfaces M1 though M4 inclusive are respectively labeled as 102₁ through 102₄. In this illustrative representation, the incident laser beam is deflected from surface M1 by an angle of 2θ with surfaces 102₁ and 102₃ being angled in the same direction and surfaces 102₂ and 102₄ being angled in the same but opposite direction from surfaces 102₁ and 102₃. Structurally, the hub 100 may be manufactured from aluminum or other suitable material with the mirrored surfaces being attached thereto to the beveled faces thereof.

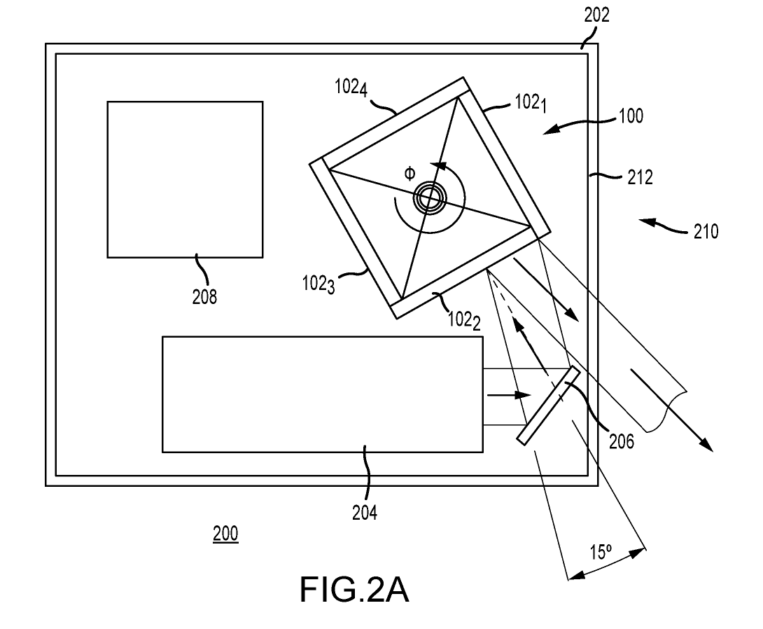

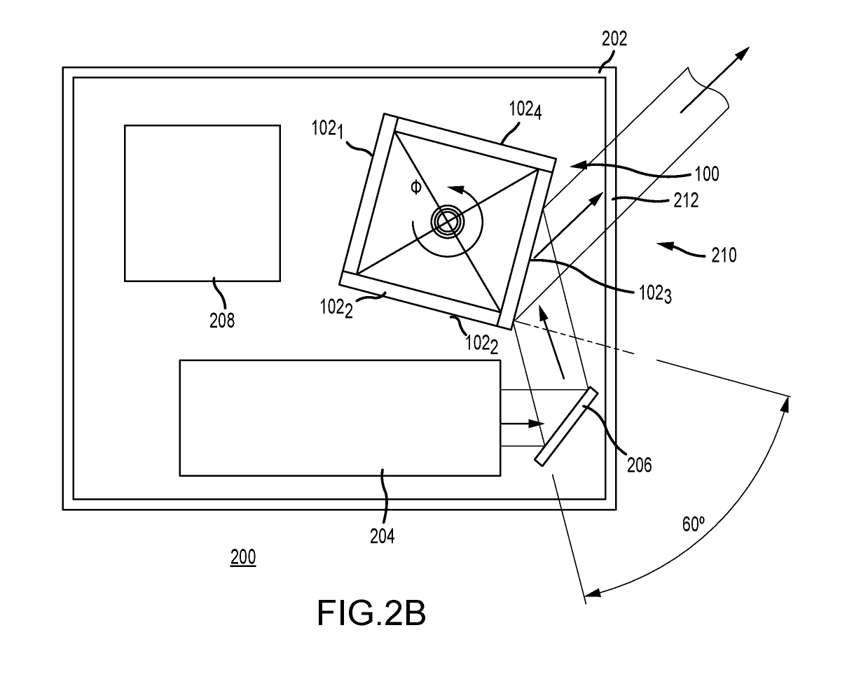

With reference additionally now to FIG. 2A, a cut-away, top plan view of a possible implementation of a portion of a laser safety screen 200 in accordance with the principles of the present invention is shown incorporating the rotating hub 100 of the preceding figure wherein the angle of the incident laser beam to a point on a mirrored surface 102₂ of the hub 100 is 15°.

The laser safety screen 200 comprises, in pertinent part, an enclosure 202 for surrounding a laser source 204 and the motor driven hub 100. Control of the hub 100 and laser source 204 is handled by controller board 208 comprising a microprocessor or other computational element and its associated circuitry. Laser output from the laser source 201 is directed toward a mirror 206 and then to the rotating hub 100. This incident laser light is then reflected from one of the mirrored surfaces 102₁ through 102₄ through an aperture 210 in the housing 202. A translucent panel 212 is affixed over the aperture 210 as illustrated.

As indicated in this particular implementation of the laser safety screen 200, the laser energy reflected from the hub 100 at 15° is at one limit of the aperture 210.

With reference additionally now to FIG. 2B, an additional cut-away, top plan view of the implementation of a portion of the laser safety screen 200 of the preceding figure is shown wherein the angle of the incident laser beam to a point on a mirrored surface 102₁ through 102₄ on the hub 100 is 60°. As also indicated in this particular implementation of the laser safety screen 200, the laser energy reflected from the hub 100 at 60° is at the other limit of the aperture 210.

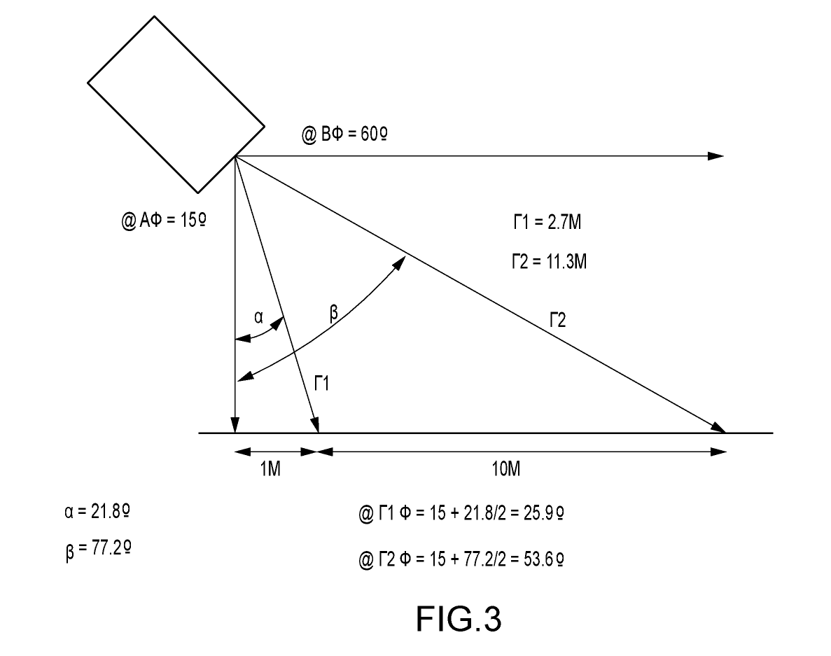

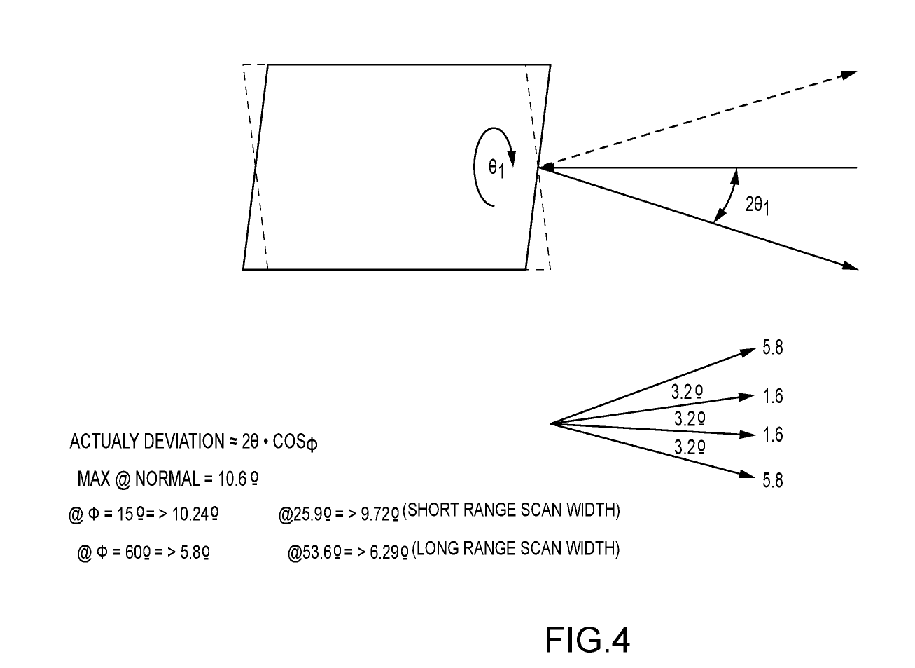

With reference additionally now to FIGS. 3 and 4, the mathematical relationships between the short range and long range scan angles are indicated with respect to the representative embodiment of FIGS. 2A and 2B. In the representative embodiment illustrated, θ₁ and θ₃ have been set at 2.4° and θ₂ and θ₄ have been set at 0.8°. The hub 100 has been conveniently formed as a parallelogram for ease of manufacture. As shown in FIG. 4 in particular, this results in the provision of evenly spaced 3.2° beams although the angles may be set at any desired angles and spacing.

As indicated, the actual deviation is substantially 2θtimes the cosine of ϕ with the max@ normal equal to 10.6°. At the 15° indicated in FIG. 2A, the deviation is substantially 10.24°. Concomitantly, at the 60° indicated in FIG. 2B, the deviation is substantially 5.8° for an almost 2:1 variation between the short range and long range values.

With particular reference to FIG. 3, at angles α=21.8° and β=77.2° ϕ is shown to equate to 25.9° and 53.6° respectively. Referring back to FIG. 4 25.9° corresponds to a short range scan width of 9.72° while 53.6° corresponds to a long range scan width of 6.29°.

The laser safety screen 200 in accordance with the present invention produces a series of points with only a single laser source 204 and hub 100 and offers significant advantages over the use of fan beams and much more expensive and computationally intensive survey scanning equipment. In operation, a laser safety screen 200 in accordance with the principles of the present invention produces a uniform pattern which essentially fills a volume and serves to protect that volume such that anything introduced therein can be utilized to trigger an alarm. The ray path produced is essentially not linear inasmuch as it starts out wide and then shrinks back. Importantly, the resultant shape is non-linear and provides much larger coverage at short range for a given long range. In certain applications, two laser safety screens may be utilized back-to-back to provide almost 100% coverage of a given volume.

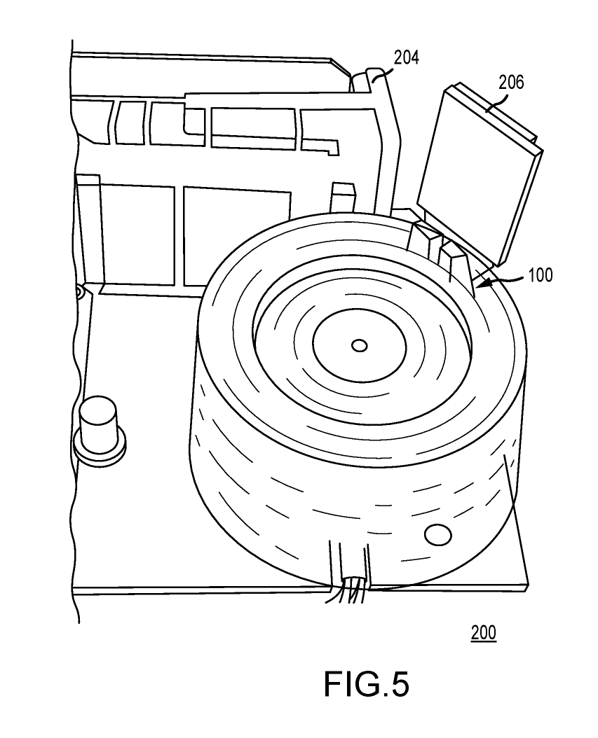

With reference additionally now to FIG. 5, an image of a prototype laser safety screen 200 in accordance with the principles of the present invention is shown illustrating a laser source 204, mirror 206 and hub 100 rotating at a representative speed of substantially between 1800 to 3000 RPM. In this prototype system, the effective detection angle is substantially 90° with an effective angle of 27.5° to 72.5°.

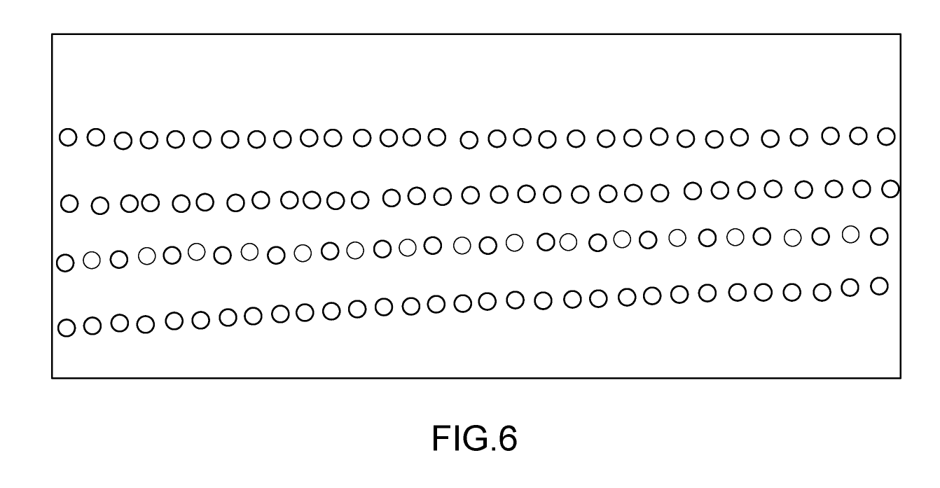

With reference additionally now to FIG. 6, an image of a laser pattern produced by the prototype laser safety screen 200 of the preceding figure is illustrated as may be detected as the hub 100 is rotated. In this particular implementation of the laser safety screen 200 a laser pattern is produced comprising four stages as detected on a vertical surface. The measured interval is 0.9° moving 0.1° to 0.25 after detection.

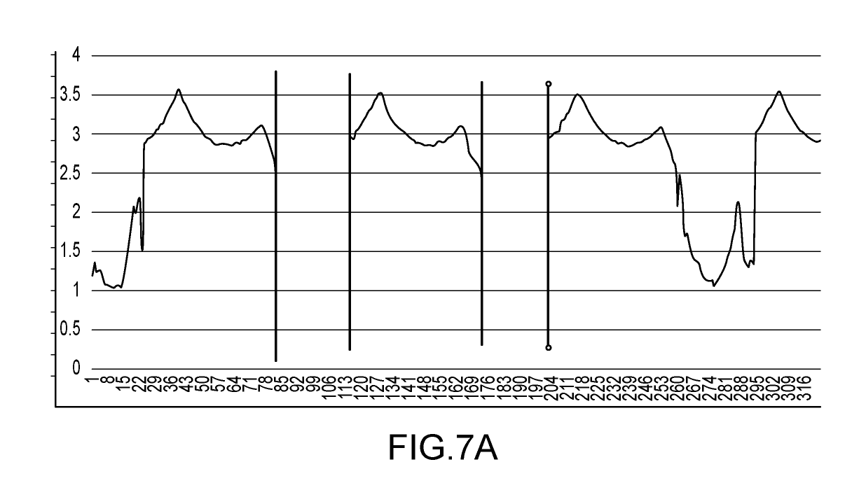

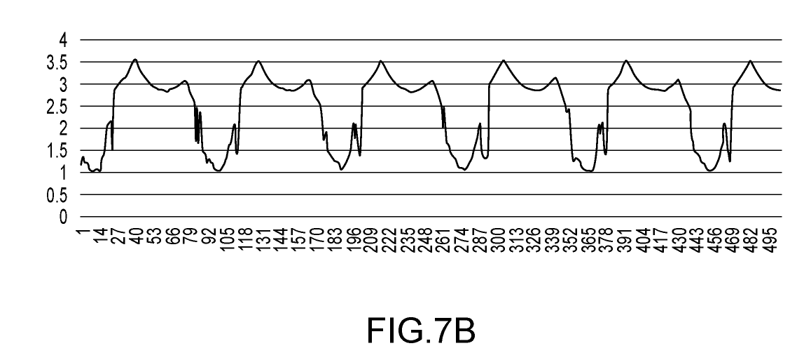

With reference additionally now to FIG. 7A, a graphical illustration of a detection data sample of detected data by time is shown. In this figure, the laser is repeated four times from 0° to 90° and laser utilized uses only the values between 27.5° and 72.5° as measurement information. The effective measurement range is 90° and it does not operate between 72.5° and 27.5° in the portions obscured between the vertical bars on the graph.

With reference additionally now to FIG. 7A, a related graphical illustration to that shown in the preceding figure is depicted wherein the measurement error is 2.0 cm to 3.0 cm; the effective measurement interval.

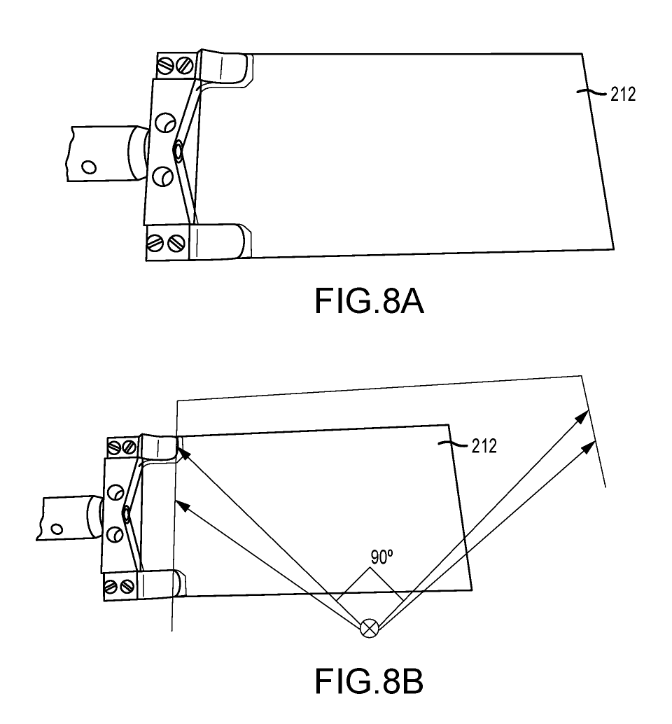

With reference additionally now to FIG. 8A, an image of the prototype laser safety screen of FIGS. 5 and 6 is shown wherein contamination has been introduced in the output laser pattern. The panel indicated is analogous to the translucent panel 212 shown in FIGS. 2A and 2B. In this illustration, it is shown that beyond a certain level of dust, contamination or other obscuring substances on the detection area of the laser safety screen it is then possible to detect this situation utilizing an automatic pollution measurement system and send a warning message if the pollution or contamination is sufficiently serious and thus hinders the effective operation of the laser safety screen. Corrective measures can then be undertaken to remove the contamination and resume proper operation.

With reference additionally now to FIG. 8B, another view of the image of the preceding figure is depicted showing a setup for producing experimental results at 90°.

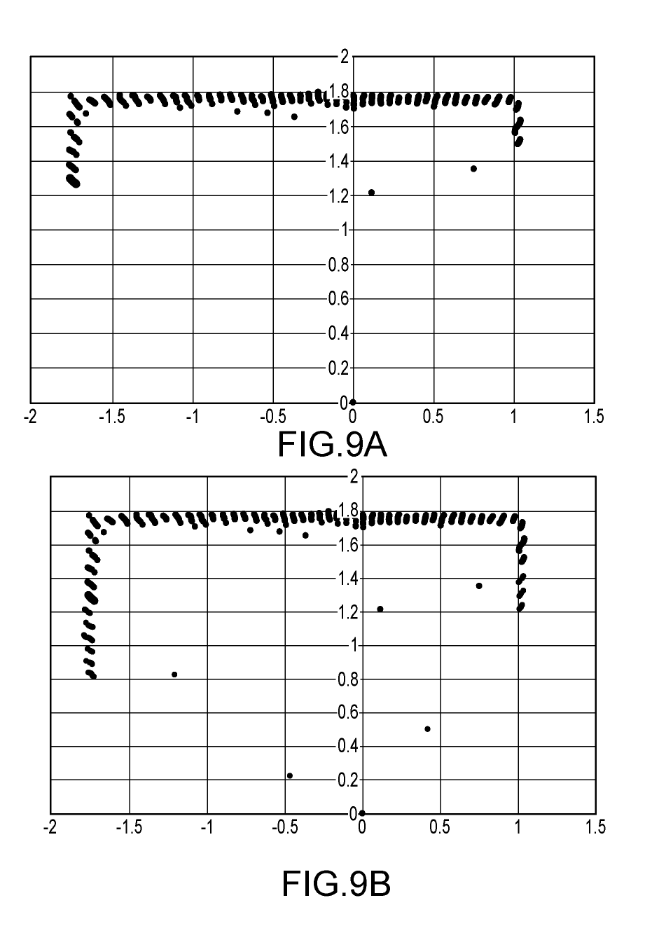

With reference additionally now to FIG. 9A, the experimental results of the setup of FIG. 8B at 90° is illustrated.

With reference additionally now to FIG. 9B, the experimental results of the setup of the prototype laser safety screen of the preceding figures at 106°, 65.5° to 12° is illustrated.

While there have been described above the principles of the present invention in conjunction with specific apparatus, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features which are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The applicants hereby reserve the right to formulate new claims to such features and/or combinations of such features during the prosecution of the present application or of any further application derived therefrom.

As used herein, the terms “comprises”, “comprising”, or any other variation thereof, are intended to cover a non-exclusive inclusion, such that a process, method, article, or apparatus that comprises a recitation of certain elements does not necessarily include only those elements but may include other elements not expressly recited or inherent to such process, method, article or apparatus. None of the description in the present application should be read as implying that any particular element, step, or function is an essential element which must be included in the claim scope and THE SCOPE OF THE PATENTED SUBJECT MATTER IS DEFINED ONLY BY THE CLAIMS AS ALLOWED. Moreover, none of the appended claims are intended to invoke paragraph six of 35 U.S.C. Sect. 112 unless the exact phrase “means for” is employed and is followed by a participle.

1. A laser safety screen comprising:
an enclosure;
a laser source;
a rotating hub for reflecting laser energy from said laser source through an aperture in said enclosure, said hub comprising a polygon having at least one surface at an angle other than parallel to the rotational axis of said hub.

2. The laser safety screen of claim 1 wherein said polygon surfaces are each at differing angles other than parallel to the rotational axis of said hub.

3. A hub for a laser safety screen comprising:
a motor driven polygonal structure having planar mirrored surfaces on each side of said polygonal structure, each of said mirrored surfaces of said polygonal structure being positioned at determined differing angles with respect to incident laser energy.

4. The hub of claim 3 wherein said polygonal structure comprises a cube.
